(19) United States
(12) Patent Application Publication
(10) Pub. No.: US 2016/0263601 A1
(43) Pub. Date: Sep. 15, 2016

(54) PUMP STYLE DISPENSE MECHANISM FOR FLOWABLE PRODUCT PACKAGING

(71) Applicant: Liqui-Box Corporation, Richmond, VA (US)

(72) Inventor: Kenneth Micnerski, Hammondsport, NY (US)

(21) Appl. No.: 15/065,149

(22) Filed: Mar. 9, 2016

Related U.S. Application Data
(60) Provisional application No. 62/130,109, filed on Mar. 9, 2015.

(51) Int. Cl. B05B 11/00; B65D 25/48

(52) U.S. Cl. CPC B05B 11/3001; B65D 25/48; B05B 11/0037; B05B 11/3028

(57) ABSTRACT

A liquid evacuation system for removing under controlled conditions a liquid, such as wine, juices, chemical products such as detergents, from a flexible pouch using a mechanical pumping mechanism, such as a piston pump or a diaphragm pump, attached to the pouch wherein when the mechanical pumping mechanism is activated for the removal of liquid from the pouch; the liquid is removed from the pouch and a container is filled under controlled conditions; thereby avoiding air entrainment and the mechanical pumping mechanism is deactivated stopping the flow of liquid from the pouch.

### CROSS REFERENCE TO RELATED APPLICATIONS

This application claims the benefit of U.S. Provisional Application No. 62/130,109, filed Mar. 9, 2015, which is incorporated by reference herein in its entirety.

### TECHNICAL FIELD

This invention relates to pouches containing liquids and valve assemblies for dispensing liquids from these pouches.

### BACKGROUND

Flowable products like wine, juice, condiments and liquid chemical products, such as detergents have been dispensed from flexible pouches and are widely known as “bag in box” products. These products rely on typical gravity flow taps located in the bottom of the bag or pouch that is positioned in a box container. A number of undesirable issues occur with such dispensing of liquids using gravity flow that include product remaining in the pouch due to lack of head pressure or inability of the pouch packaging material to collapse around the product as it is being drained from the pouch. Also, the dispensing tap must be placed at the bottom of the pouch to drain the pouch completely. Further, as liquid is dispensed from the pouch flow becomes slower particularly, when the pouch is about empty. By having to position the dispensing tap at the bottom of the container containing the pouch, a wine glass, for example, has to be placed below the container which under a number of conditions is cumbersome and consumes space that might otherwise be used; for example, the box or carton must be placed at the edge of a table or counter top or the carton is elevated by hand over the glass using the persons free hand to manipulate the gravity dispense tap.

It would be desirable to have a fluid dispensing system wherein the tap could be positioned anywhere on the pouch such as the top or side of the pouch so that a variety of configurations could be used and still drain the pouch completely and wherein flow would be at a continuous rate even when the pouch is close to being empty thereby allowing the pouch or carton containing the pouch to be placed anywhere on a table or countertop without the need for elevating the carton over the glass or container while still having the ability to have the glass directly under the dispense tap. The unique pump evacuation system of this invention obviates the above problems with gravity fed pouches that are in a box or as stand-alone pouches.

### SUMMARY

A container assembly or a liquid evacuation system for flexible pouches containing liquids comprising a flexible pouch for holding liquids, a spout attached to the pouch for removing liquid from the pouch in any position such as the top, bottom or side of the pouch whereby the liquid can be drained from the pouch under controlled conditions and the pouch can be drained completely of liquid wherein a mechanical pumping mechanism is positioned in relation to the spout for removal of liquid from the pouch and a tap that is positioned in relation to the mechanical pumping mechanism to dispense liquid into a container on activation of the mechanical pumping mechanism and wherein the pumping mechanism comprises a diaphragm pump or a piston dispensing pump.

### BRIEF DESCRIPTION OF THE DRAWINGS

FIG. 1 illustrates a typical flexible bag in a box container configuration having a spout and mechanical pumping mechanism attached to the spout.

FIGS. 2A and 2B illustrate a manual piston dispensing pump that can be attached to a spout of a bag in box container.

FIGS. 3A and 3B illustrate a diaphragm style pump that can be attached to the spout of a bag in box container.

### DETAILED DESCRIPTION OF ILLUSTRATIVE EMBODIMENTS

The invention is directed to a container assembly for dispensing liquids from a pouch and to a liquid evacuation system for flexible pouches containing flowable liquids. A variety of pouch designs can be used. The pouch design that is of particular interest is a flexible bag in a box wherein a flexible bag or pouch is positioned in a box or other container to hold the bag. Such a bag in a box is currently used for wines and juices of various types. However, other liquids such as, liquid soaps, cleaning agents, oils, ointments and cosmetics can be dispensed from flexible pouches and in a bag in a box configuration. Also, a free standing flexible pouch can be used without a box or other supporting means. Other flexible pouch designs and containers and supports also may be used.

Typically, a flexible bag in a box configuration comprises a flexible bag positioned in a box or other holder configuration. A spout is attached to the bag through a hole in the box or container to allow flow of liquid from the pouch. Currently, with such a configuration, the dispensing of liquid through the tap is made possible by gravity flow from the pouch into a container which requires the spout to be positioned at or near the bottom of the flexible bag and box. This results in a number of problems. There must be sufficient room below the pouch to place the container to receive the liquid being dispensed and this may be inconvenient depending on available space available. Under some circumstances it may be very desirable to place the spout at the top or side of the container which would not be possible when a gravity feed is used. Also, there are often problems with complete collapse of the flexible bag to create an equilibrium between the outside pouch pressure and inside the pouch pressure resulting in a diminished or complete stoppage of liquid flow. The result is that the pouch must be taken out of the box and cut open or squeezed to extract the retained contents of liquid. Further, as less liquid is in the bag, flow of the liquid by force of gravity becomes slower. Also, there is not a convenient method to dispense exact amounts of liquid to each container, for example, it is difficult to dispense the identical amount of wine into each glass. By using a pumping system of this invention, the above problems are readily avoided and accurate metering of liquids can be achieved by sizing the dispensing part of the mechanical pumping to a desired amount of fluid.

The liquid evacuation system of this invention for liquid containing flexible pouches comprising a spout attached to the flexible pouch in any position whereby the liquid can be drained from the pouch under controlled conditions and the pouch can be drained completely of liquid. This is accomplished by a mechanical pumping mechanism that is positioned in relation to the spout and can be positioned in the spout itself if desired. When the mechanical pumping mechanism is activated, liquid is pumped from the pouch into a container. There are no problems with pumping all of the liquid from the pouch and completely emptying the pouch as a vacuum is created by pulling the liquid out of the pouch and creating a condition wherein as the flexile pouch collapses around the liquid, the liquid is completely evacuated from the pouch. In the event there is a problem with the removal of all of the liquid from the pouch, a helical coil or dip strip can be inserted into the pouch. The pumping mechanism can be positioned at any place on the pouch and is not limited to the bottom of the pouch as with the current gravity feed pouches. This allows placement of the pouch in a variety of positions and allows, for example, filling of a container with liquid from the top of the pouch which could not be accomplished with the current gravity feed dispensing of liquids. Further, the pump would allow liquids to flow at a constant rate since the pump dispenses liquid at a constant rate and the liquid would not flow slower as the pouch is emptied as occurs with a gravity feed. Also, a pump can be controlled to dispense a certain amount of liquid, for example, 6 oz. of soda or beer and 2 oz. of liquor and the like. Also, exact amounts of liquid chemicals can be dispensed, for example, cleaning liquids, solvents, oils and the like. Pumping mechanisms that can be used in this invention comprise diaphragm pumps or a piston pump but are not limited to such pumping mechanisms. The pumping mechanism can be activated by a motor to automatically dispense an exact amount of liquid desired.

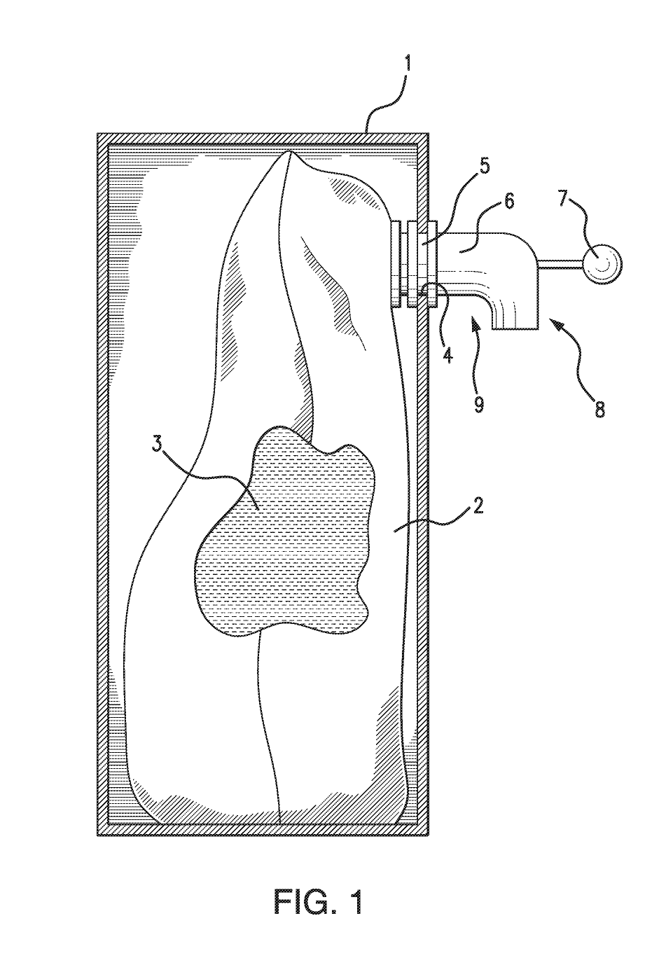

FIG. 1 illustrates a typical flexible pouch in a box container configuration having a spout and mechanical pumping mechanism attached to the spout. A flexible pouch 2 containing product 3, such as wine, is positioned in a box 1. A spout 5 is attached to the bag 2 through an opening 4 in the box 1 and has a tap 8 attached thereto and is positioned in the box 1 and is shipped in the box 1 and pulled out by the consumer when the bag is to be used. A piston pump or diaphragm pump 6 is attached to the spout 5 to evacuate product or fluid 3 from the pouch 2. A lever 7 is attached to the pump 6 to activate the pump 6. A void or recess 9 is incorporated into the tap body to provide a location for the rim of the glass or container to be positioned thus holding the dispense tap and carton in place and supporting the pump dispense tap to absorb or act as a mechanical means or fulcrum to facilitate the pumping action; this also places the glass or container at the point of dispense to minimize splash of product when dispensed.

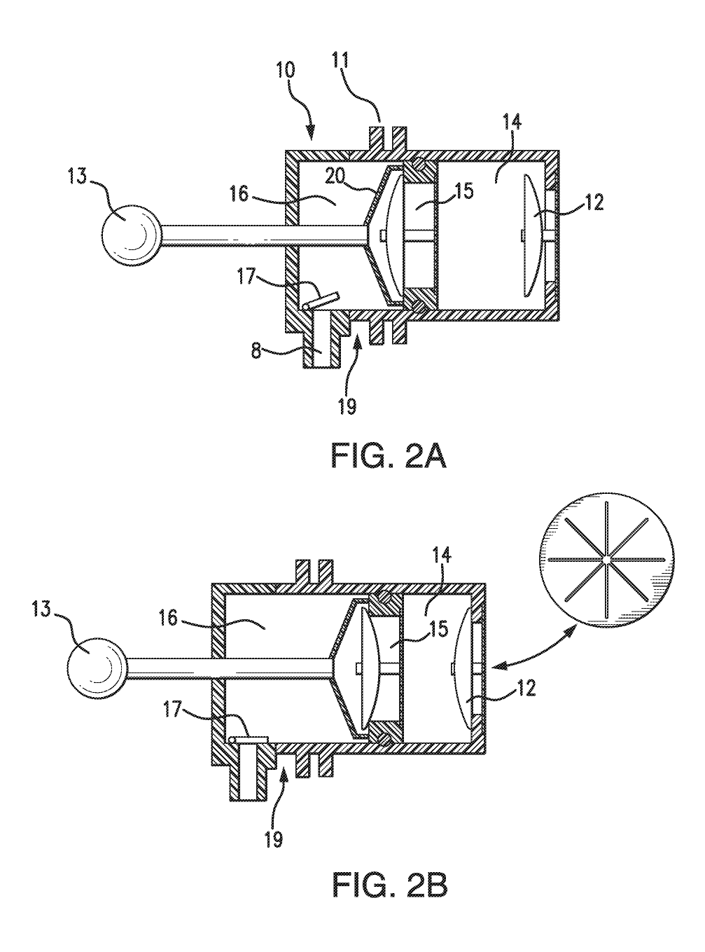

FIG. 2A illustrates a manual piston dispensing pump attached to a spout of a bag in box container. The piston dispensing pump 10 is attached to the spout 5 of pouch 2 (shown in FIG. 1) at flange 11. When nob 13 is manually pulled, sealing plate 20 is moved away from check valve 12 and opens check valve 12 allowing product to flow from the pouch (FIG. 1) into the cavity 14. Check valve 15 closes thereby preventing product to flow into cavity for fluid 16. Check valve 17 allows product to flow from cavity 16 and is dispensed through dispensing tap opening 18 into a container not shown. In FIG. 2B, when nob 13 is pushed backward, check valve 17 is closed and check valve 12 is closed and check 15 is open and fluid flows from cavity 14 into cavity 16. A space 19 is used to position the glass or cup (not shown).

Cavity 14 can be sized to dispense specific quantities of product. Internal springs may be added to allow cycling and single stage action. Location of the spring or tensioning device would be inside cavity 14 on the barrel bottom next to the seal and making contact with the piston thus forcing the piston forward, dispensing the dose of liquid while holding the piston forward and maintain liquid between the piston and the seal. The spring could be in front of the piston if desired and creating a condition that the pump action is activated forward to dispense liquid.

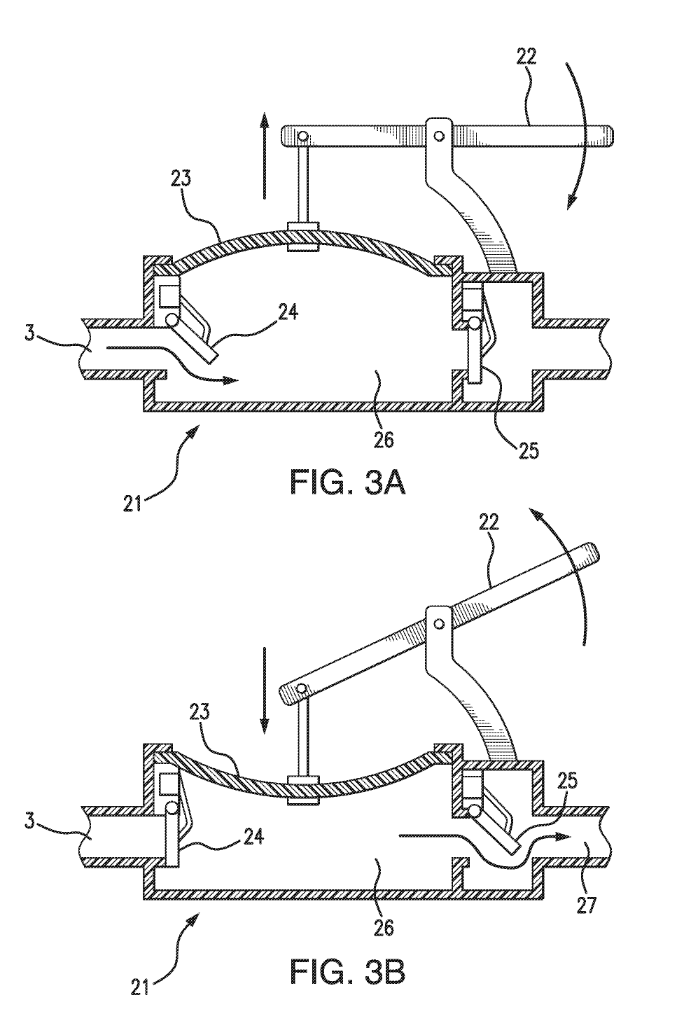

FIGS. 3A and 3B illustrate a diaphragm style pump 21 that can be attached to the spout of a pouch. Handle 22 is attached to the diaphragm 23 of the diaphragm pump 21. When activated by pushing the handle 22 down, the action of the diaphragm 23 opens check valve 24 and allows product 3 (FIG. 1) to flow into cavity 26 and closes check valve 25. Handle 22 when released or pushed upward, closes check valve 24 and opens check valve 25 and allows product 3 to flow from cavity 26 into dispensing port 27. A container, preferably, a cup is positioned in relation to the dispensing port and filled with product.

Materials used for the bag and the pumping mechanism, preferably are recyclable plastics, such as polyethylene, polypropylene and a variety of copolymers thereof. In a typical usage, the box, bag, dispensing valve and pumping mechanism are recycled after the liquid from the bag is dispensed. It is not practical to reuse such a system since the costs involved in cleaning are expensive and high and results cannot be guaranteed.

To protect the liquid product in the pouch a sealing film can be positioned over the spout and a piercing mechanism installed that will pierce the seal before liquid is dispensed from the bag.

### Parts List

FIG. 1

1. Box

2. Pouch

3. Product

4. Opening in Box

5. Spout

6. Dispensing Pump or Diaphragm Pump site

7. Lever to actuate 6

8. Tap

9. Void for cup or vessel

FIGS. 2A and 2B Piston Dispensing Pump

10. Piston Dispensing Pump

11. Flange attached to spout 5 of pouch

12. Check valve

13. Knob for manual operation of piston

14. Cavity for product

15. Check valve

16. Cavity for fluid

17. Check valve

18. Dispense opening

19. Space for cup

20. Sealing plate

FIGS. 3A and 3B Diaphragm Pump

21. Diaphragm pump

22. Handle

23. Diaphragm

24. Check valve

25. Check valve

26. Cavity

27. Dispensing port

What is claimed:

1. A container assembly for dispensing liquids comprising:
a. a flexible pouch for holding a liquid;
b. a spout attached to the pouch for removing liquid from the pouch;
c. a mechanical pumping mechanism positioned in relation to the spout for the removal of liquid from the pouch;
d. a tap positioned in relation to the mechanical pumping mechanism and connected thereto to dispense liquid into container positioned in close relation to the tap;
whereby when the mechanical pumping mechanism is activated, a flow of liquid is pumped by the mechanism into a container and whereby the flexible pouch collapses as liquid is being dispensed and forces fluid out of the flexible pouch without intrusion of air and wherein the container is filled with a desired amount of liquid fluid flow being stopped on deactivation of the when the pumping mechanism.

2. The container assembly of claim 1 wherein the flexible pouch is a stand-up pouch.

3. The container assembly of claim 1 wherein the container assembly comprises a flexible pouch positioned in a box structure.

4. The container assembly of claim 1 wherein the mechanical pumping mechanism comprises a manual piston pump.

5. The container assembly of claim 1 wherein the mechanical pumping mechanism comprises a diaphragm pump.

6. The container assembly of claim 1 wherein the mechanical pumping mechanism is positioned in the dispensing tap with an external manual actuated means to activate and deactivate the pumping mechanism.

7. The container assembly of claim 1 wherein the mechanical pumping mechanism is sized to accurately meter out a specified amount of liquid.

8. The container assembly of claim 7 wherein the tap is positioned at a top part of the flexible pouch.

9. The container assembly of claim 7 where the mechanical pumping is driven by a motor to allow automated dispensing of liquid when the motor is activated.

10. The container assembly of claim 8 wherein a helical coil is attached for the evacuation of liquid out of the pouch.

11. The container assembly of claim 8 wherein a dip strip is attached for the evacuation of liquid out of the pouch.

12. The container assembly of claim 1 wherein the container assembly comprises a flexible recyclable plastic structure.

13. The container assembly of claim 1 wherein the plastic structure comprises a recyclable structure of polyethylene, polypropylene or copolymers thereof.

14. A liquid evacuation system for removing under controlled conditions a liquid from a flexible pouch using a mechanical pumping mechanism attached to the pouch comprising:
a. activating the mechanical pumping mechanism for the removal of liquid from the pouch;
b. removing liquid from the pouch to fill a container under controlled conditions thereby avoiding air entrainment c. deactivating the mechanical pumping mechanism thereby stopping the flow of liquid from the pouch.

15. The liquid evacuation system of claim 14 wherein the mechanical pumping mechanism is adapted to disperse a given amount of liquid.

16. The liquid evacuation system of claim 14 wherein the mechanical pumping mechanism comprises a manual piston pump.

17. The liquid evacuation system of claim 14 wherein the mechanical pumping mechanism comprises a diaphragm pump.
